(19) United States
(12) Patent Application Publication
(10) Pub. No.: US 2015/0358647 A1
(43) Pub. Date: Dec. 10, 2015

(54) Data Network, Method and Playback Device for Playing Back Audio and Video Data in an In-Flight Entertainment System

(71) Applicant: LUFTHANSA TECHNIK AG, Hamburg (DE)

(72) Inventors: Martin SAKOWSKI, Hamburg (DE); Arndt MONICKE, Hoisdorf (DE); Samer ABDALLA, Hamburg (DE)

(21) Appl. No.: 14/760,156

(22) PCT Filed: Jan. 7, 2014
(86) PCT No.: PCT/EP2014/050113

§ 371 Date: Jul. 9, 2015

(30) Foreign Application Priority Data
Jan. 9, 2013 (DE) 10 2013 200 171.1

(51) Int. Cl. H04N 21/214; H04N 21/43; H04N 21/235; H04N 21/254; H04N 21/4627; H04N 21/835; H04N 7/56; H04N 21/4405

(52) U.S. Cl. CPC H04N 21/2146; H04N 7/56; H04N 21/4307; H04N 21/4405; H04N 21/2541; H04N 21/4627; H04N 21/835; H04N 21/2353

(57) ABSTRACT

Data network in an in-flight entertainment system for playing back audio and video data (1b, 1a), which comprises a playback device (21) for reading out the audio and video data (1b, 1a) from a data carrier (1), a decoder (22) and an amplifier (24), it being possible to transmit the audio data (1b) read out in the playback device (21) to the amplifier (24), and it being possible to transmit read-out video data (1a) in an encrypted manner to the decoder (22), wherein the data network is configured to play the video data (1a), which are in high resolution, substantially synchronously with the audio data (1b), and to transmit both sets of data separately from one another to the decoder (22) or the amplifier (24).

The invention relates to a data network for playing back audio and video data in an in-flight entertainment system having the features of the preamble of claim 1, and to a corresponding method for playing back audio and video data in an in-flight entertainment system having the features of the preamble of claim 8. The invention further relates to a playback device for reading out audio and video data of a data carrier having the features of the preamble of claim 15.

In-flight entertainment systems (also known as “IFE systems”) provide airplane passengers with audio and video data for entertainment purposes via electronic devices.

In order for the data to be played back in a manner comfortable for the viewer, video data are shown at a particular frame rate, so that the playback appears flowing to the human eye. In addition, images must be shown at a particular number of bits, so that sufficient image information is available to show a clear image.

Audio data are played back at a particular number of samples per second, so that a sound is produced which is pleasant for the human ear.

In the case of combined playback of audio and video data, said data must be played back synchronously. Any time lapse which might occur during playback of images and sounds which belong together may not exceed a certain limit.

In addition, it is extremely important to ensure the copyright protection of the played back data. This means that measures must be provided for preventing unauthorized access. For playing Blu-rays, it is vital to adhere to the requirements of Advanced Access Content System (AACS) Adopter Agreements in this connection. In order to control the use of digital media, digital rights management systems (DRM systems) may be used, which constitute a technical security measure by means of which holders of rights to information assets are given the option of enforcing the way in which their property is used by users on the basis of a user agreement made in advance.

Moreover, the IFE system should react to user input as far as possible without any significant delay so that the use or menu navigation is not perceived as uncomfortably awkward.

When implementing these requirements, two fundamental points should be taken into account: in principle, every data processing operation requires a certain runtime. The runtime leads to a delay between the time at which the data are provided at the system input and the time at which the data are played back at the system output. This delay is known as latency.

However, on account of different influencing factors, such as the variable bitrate of the video signal or fluctuating processor usage, the latency is not always the same for the same operation. Deviations from the mean latency are known as runtime fluctuations, it being possible for the total of the runtime fluctuations to significantly increase in the case of a plurality of successive operations.

If the runtime fluctuations reach a certain magnitude, the data cannot be provided to the playback output of the system at the required time or in the required order, with the result that the playback becomes faulty.

There are various approaches in the prior art for overcoming this problem of latency and runtime fluctuations.

One option for reducing latency and runtime fluctuations is to use point-to-point systems, in which each data source is separately connected to the destination of the data, or the “data sink”. Although a data network can be entirely dispensed with in this manner and a range of potential problems excluded, point-to-point connections do not provide flexible data paths.

US 2009/0073316 A1 discloses point-to-point transmission of audio and video signals from a source to a sink. The source device calls up the total latency of the video signal (sum of the latencies of the devices of the video transmission path) via an up-line, and transmits the total latency of the video signal to the devices of the audio transmission path via the audio transmission path. Using a controller arranged in the audio path, the difference between the total latency of the video signal and the audio latency is determined and the audio signal is delayed by this difference. By calling up the total latency of the video signal via the up-line and carrying out dynamic control of the audio delay in the controller, an undesired additional delay is generated.

In network-based systems, which are used for playing back audio and video data on different playback devices, the following steps are usually carried out successively once the data have been read out, for example from a data carrier.
a) Data compression
   The raw data are compressed by a suitable data format, in order to achieve the bandwidth required for continuous data transmission. This process takes place separately for audio and video data.
b) Creation of data containers
   The compressed audio and video data are combined according to the container format used.
c) Data encryption
   The data containers are encrypted by means of the algorithm used by the respective DRM system.
d) Continuous data transmission
   The encrypted data are packed in Ethernet-compatible data packets and sent via the network to the different playback devices (data streaming). The data packets are unpacked again at the playback device.
e) Data decryption
   The data containers are decrypted according to the associated DRM decryption algorithm.
f) Resolution of the data containers
   The data containers are resolved and the audio and video data are again treated separately.
g) Data decompression
   The decrypted data are decompressed.
h) Synchronization
   The decompressed data are temporarily stored, a synchronization method ensuring that the audio and video data are relayed from the temporary memory to the following digital-analogue data converter so as to be simultaneously played back following the conversion.
i) Digital-analogue data conversion
   The digitized data are converted to analogue signals.
j) Playback
   The data are output by playback devices, such as screens and loudspeakers.

In order to compensate for the runtime fluctuations occurring during the method, a sequence number and a time stamp are added to the data packets by the communication protocol of the network. The data are written to a temporary memory (buffer) and read out within a specific clock pulse. This ensures that the data are available to the successive operations at a predetermined time. In this case, the greater the time intervals are between the read-out processes, the greater are the runtime fluctuations which can be compensated for. This procedure is described in US 2011/0231566 A1 for example. A change in the packet sequence brought about by the compression or transmission of the data is also corrected in this manner.

In order to reduce the latency, it is known to optimise the mode of operation of a single or a plurality of buffers. A number of methods are known for this purpose.

GB 2 417 866 A discloses simultaneously using a plurality of buffers. In this case, the buffers are used in quick succession one after the other. If one buffer is already processing data when addressed, the next free buffer is activated. In addition, the buffers are called up in sequence. If the called-up buffer has stored a complete data packet, said data packet is sent. If this is not the case, an empty data packet is transmitted instead. Following transmission, the data packets are again temporarily stored and sorted according to the procedure described above.

WO 2011/031853 A1 discloses a method in which continuous data transmission (data streaming) is begun at the smallest possible bitrate and is later adaptively amended. The temporary storage time can be reduced on account of the smaller amount of data. In the course of the continuous data transmission, the bandwidth provided by the network is measured and the bitrate is increased accordingly. At the same time, the storage space of the buffer is increased to its maximum. Subsequently, the bitrate can be adjusted again in the event of a change in the available bandwidth.

Moreover, US 2006/0230171 A1 and US 2007/0011343 A1 disclose methods for adaptively adjusting the frame rate, which reduce the latency when an alternative channel is selected for continuous data transmission. As soon as a new channel is selected, an initiation sequence reduces the transmitted frame rate and removes the buffer used for compensating for runtime fluctuations. The free temporary memory immediately begins to store the data from the new channel. As soon as the buffer has been filled to a particular value, playback begins and the frame rate is gradually increased up to the desired maximum.

For the purpose of synchronisation, it is known for example from CA 2676075 A1 to use a plurality of clock generators and a time stamp imprinted on the data packets. The transmission time, which can be measured by means of the time stamp, is used, together with a delay calculated separately for audio and video data, for dynamically adjusting the output clock pulses.

US 2008/0187282 A1 discloses a system for synchronizing audio and video playback, in which encoded or compressed audio/video data are transmitted in a single, uniform audio/video packet data stream from a data source to audio/video playback devices via a distribution network. The data source is a master timing component of the system. The decoder in an audio/video playback device plays the audio/video data in such a way that a fixed delay between the source data and the presentation of the video or audio is maintained, synchronization between all video and audio playback devices of less than 66 ms being aimed for.

Both the systems having point-to-point connections and the network-based systems have disadvantages. The main disadvantage in point-to-point connections is the very low flexibility of the data distribution. The data present on a device can only be transmitted to another device if both devices are interconnected via a separate line.

In this case, the number of cables used results in a high weight, which is a significant disadvantage in particular in airplane construction.

However, the alternative network-based systems having solutions for compensating for runtime fluctuations and for synchronizing audio and video playback are affected by latency. This means that said systems increase the data runtime and thus the reaction time of the system to interactions. The operability of the system is impaired as a result.

The known solutions for reducing the latency cannot solve these problems in a satisfactory manner, in particular in the case of high-resolution video data. High-resolution video data, or “HD” (high-definition) video data is considered to be that having a resolution of 720p or more. In this case, when simultaneously using a plurality of buffers, the problem arises that a long processing and transmission time may occur in the case of large data packets. Since the data can only be played back in a predetermined sequence, packets which are transmitted more quickly have to be temporarily stored after transmission. The time saving is therefore low.

Reducing the bitrate results in a lower image quality, since less information can be transmitted per image. In addition, the reduction in the frame rate impairs the playback of movements. Furthermore, there is the risk that the playback may stall if the frame rate falls below approximately 15 frames per second.

The object of the invention is therefore that of providing a data network for playing back audio and video data in an in-flight entertainment system, as well as a corresponding method and corresponding playback device, in which the abovementioned problems are lessened.

Accordingly, in order to achieve the object, a data network in an in-flight entertainment system for playing back audio and video data is proposed, which network comprises a playback device for reading out the audio and video data from a data carrier, a decoder and an amplifier, where it is possible to transmit the audio data read out in the playback device to the amplifier, and possible to transmit read-out video data in an encrypted manner to the decoder, wherein the data network is configured to play the video data, which are in high resolution, substantially synchronously with the audio data, and to transmit both sets of data separately from one another to the decoder or the amplifier, respectively.

In order to achieve the object, a method for playing back audio and video data in an in-flight entertainment system via a data network is in addition proposed, the video data passing through the steps of
a) data compression
b) data encryption
c) continuous data transmission
d) data decryption
e) data decompression
f) digital-analogue data conversion and
g) data playback,
   and the audio data passing through at least steps a), c), e), f) and g), wherein the audio and video data are transmitted separately from one another via the data network at least in step c), and the video data, which are in high resolution, are played back substantially synchronously with the audio data.

Moreover, in order to achieve the object, a playback device for reading out audio and video data from a data carrier for an in-flight entertainment system is proposed, where it is possible to transmit the audio data read out in the playback device to an amplifier, and possible to transmit the read-out video data in an encrypted manner to a decoder, wherein the audio data and the encrypted video data, which are in high resolution, can be transmitted separately from one another to the amplifier and/or the decoder by the playback device.

On account of the separate transmission of the audio and video data, conventionally used data containers containing both audio and video data are dispensed with, making it possible to configure the data network as a whole in a much simpler manner, since the data do not need to be laboriously synchronized. The playback synchronism of the audio and video data is established by the predictability of the data runtime and a corresponding delay of the more rapid transmission path, meaning that known synchronisation methods affected by latency can be dispensed with. Advantageously, the audio and video data are also encrypted or compressed separately from one another.

The runtime of data in a system is predictable under specific conditions. The predictability is used for playing back audio and video data synchronously without having to adaptively measure the runtime or compensate for fluctuations by means of large buffers.

Due to the optimisation of the latency-affected synchronization, the runtime of the system as a whole is sufficiently low, despite data encryption and video coding, that the real-time capability is maintained.

Accordingly, the system components which are used for processing audio and video data, and the network architecture, are preferably selected such that the necessary operations are carried out in predetermined runtimes. The essential buffers are designed such that the delay caused thereby is minimal. If two different components carry out the same operation, said components are constructed such that the operation has the same runtime on both components.

The high-resolution video data preferably have a resolution of at least 720p. More preferable are resolutions of at least 1080p. 720p and 1080p denote vertical resolutions having 720 lines and 1080 lines respectively. When encrypting and transmitting video data of this kind, large data volumes occur which can, however, be played back substantially synchronously by the data network and method according to the invention.

Substantially synchronously means, in this context, that the latency between the playback of the audio and video data is below the perception threshold of a human viewer. Preferably, the audio and video data are played back at a latency of less than 0.5 seconds, preferably less than 0.3 seconds, more preferably less than 0.1 seconds.

Accordingly, the components of the data network which are used for processing the audio and video data can preferably be used such that the duration of the operations thereof is preferably deterministic. When the required processing time of the components is known and, if applicable, constant, the individual components can be assembled in such a way that synchronism of the audio and video data can also be achieved without a large number of intermediate buffers. For this purpose, the data playback of the audio or video data is delayed by a predetermined time period, wherein the data playback is preferably delayed by a time period which corresponds to the difference between the runtimes of the audio and video data.

Depending on the selected components of the network, the audio and video data require different lengths of time for transmission from the data carrier to the output device. If this time period is determined, the faster data can be delayed by the known time period, making it possible to ensure substantially synchronous presentation. In order to be able to determine the time period as simply as possible, the components used are preferably selected such that they require the same runtime for the same operation in each case.

Delaying the audio data for the purpose of synchronization with the video data preferably occurs during step e) or f). The runtime of the audio data is usually shorter, since said data are preferably not encrypted and decrypted.

Should, for any reason, the runtime of the audio data be longer than that of the video data, the video data can also be correspondingly delayed for the purpose of synchronization. The predetermined time period then likewise corresponds to the difference between the runtimes of the audio and video data.

According to the invention, the audio and video data are thus transmitted separately from one another via the data network in step c), the continuous data transmission (“data streaming”). More preferably, said data pass separately not only through step c), but also additionally steps a), e) and f). This means that said data are separately compressed, decompressed, and processed from digital to analogue signals, and are finally played back together, with the result that the data network can be configured in a less complex manner.

In this case, “played back together” means that the images are played back synchronously and simultaneously with the associated sound, without having to both be output through the same playback device.

In step a), the audio data are preferably generated having at most 48 kHz and 16 bits. This means that a compression method for the audio data is selected, which generates audio samples of no more than 48 kHz and 16 bits. This has the advantage that encryption of the audio data is not required according to the AACS, but the audio samples nonetheless have a sound quality which is sufficient to be used in an airplane.

In step a), the video data are preferably generated by intra-frame and inter-frame coding. In intra-frame coding, each individual image (frame) is compressed. Intra-frame coded individual images of this kind are known as “I-frames”. In contrast, in inter-frame coding, unchanged image elements are combined in image sequences. The “predicted frames” (P-frames) are calculated from the preceding I-frames. The image group to be transmitted is preferably compiled so as to contain images for a predetermined time period, for example one second, and is formed only of I-frames and P-frames. In addition, the initialization vector of the DRM system encryption is preferably updated on the basis of the video coding, the initialization vector being generated in part on the basis of the I-frame and in part on the basis of the following dependent frames and on the basis of individual encryption packets. It is thus possible to ensure that a packet loss, and the extent of the packet loss, is detected and then that the initialization vector for the encryption between the encoder and the decoder is synchronised again within one frame, without any additional loss of data. As a result, updating the data for the encryption is dependent on the type of image data transmitted, and not on the amount of data transmitted.

The content to be protected is preferably transmitted through the DRM system before and after encryption by means of the HDCP (High-bandwidth Digital Content Protection) encryption system and an HDMI connection. During continuous data transmission, the playback device sends the System Renewability Message (SRM) required by the HDCP standard from the data carrier to the transmitting system components at regular intervals. This makes it possible to ensure the security of the data transmission of high-resolution, AACS-protected content from the source to the sink.

Within the context of the present application, the term “continuous data transmission” means in particular “streaming media”, in which only audio/video signals and, if necessary, control data directly associated therewith are continuously transmitted. Advantageously, a quasi-real-time transmission of the audio/video signals takes place throughout the entire streaming media process. Video and audio signals are advantageously transmitted in a compressed form via a data network, the video and audio signal being converted into a compressed signal by means of an encoder. The compressed video and audio signal is then advantageously transported over a packet-oriented network, via a connectionless or connection-oriented transport protocol, in datagrams from the data source—the encoder—to one or more data sinks—the decoders. The datagrams are then advantageously converted by the data sink—a decoder—back into uncompressed video and audio signals.

Within the context of the present application, a data network is advantageously a data communication system which permits transmission of data between a plurality of autonomous data stations, preferably having equal authorizations and/or being partnership-oriented, e.g., computers, advantageously at a high transmission speed and with high quality. In this case, a data communication system is in particular a spatially distributed connection system for technically supporting the exchange of information between communication partners.

In the following, the invention will be described on the basis of preferred embodiments and with reference to the accompanying figure, in which:

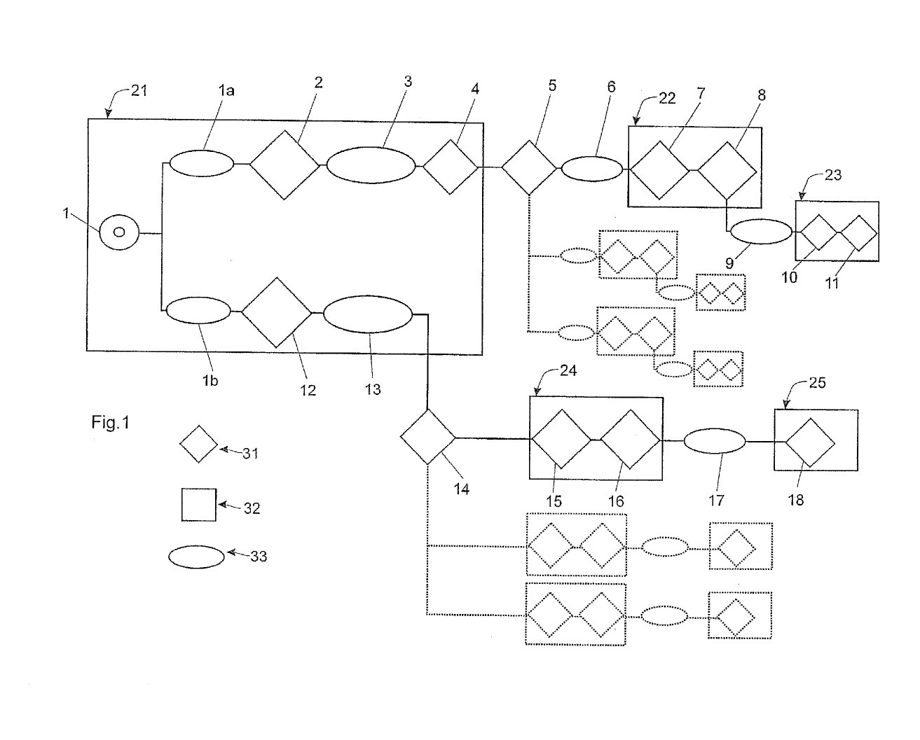

FIG. 1 is a schematic illustration of a data network according to the invention.

FIG. 1 shows a data network which comprises a playback device 21, a decoder 22, a screen 23, an amplifier 24 and a loudspeaker 25. For the purpose of clarity, these components 32 are shown as rectangles, operations 31 carried out are shown as diamonds, and data 33 as ellipses.

The data network is part of an in-flight entertainment system, in which data from a data carrier 1 are read out in the playback device 21 and played back on two playback devices, in this case on the screen 23 and the loudspeaker 25. However, the data network may comprise a plurality of additional decoders, amplifiers and playback devices, shown here by dashed outlines.

Both video data 1a and audio data 1b are read out from the data carrier 1. Once the audio and video data 1a, 1b have been read out, they are relayed along separate, in particular, deterministic, paths to the respective output device—the screen 23 and the loudspeaker 25. In this case, deterministic means that the relay path is predetermined and fixed, the runtime thus also being predetermined and preferably constant.

The video data 1a are processed within the playback device 21 by means of video data compression 2 into a compressed video data signal 3. The data format may be H.264 or MPEG2, for example. Subsequently, video data encryption 4 takes place in the playback device 21, during which the compressed video data 1a are encrypted by means of a cryptographic algorithm. The algorithm is dependent for example on the requirements of the DRM system used.

Subsequently, the encrypted, compressed video data 1a are sent in a continuous video transmission 5 via an Ethernet connection to a decoder 22. However, if required, the data may also be simultaneously sent to a plurality of decoders 22. The process of continuous data transmission 5 is also known as “data streaming” or simply “streaming”. As mentioned, within the context of the present application, the term “continuous data transmission” means in particular “streaming media”, in which only audio/video signals and, if necessary, control data directly associated therewith are continuously transmitted.

The decoder 22 decrypts the encrypted video data signal 6. Video data decompression 8 then follows the video data decryption 7 in the decoder 22, during which the decrypted data are decompressed. The signal is relayed to the screen 23 via HDMI video data transmission 9 by digital-analogue video data conversion 10 being carried out so that video output 11 to the user is subsequently possible.

The audio data 1b reach the loudspeaker 25 from the data carrier 1 separately from the video data 1a. Once the audio data 1b have been read out, audio data compression 12 takes place within the playback device 21, during which the audio data 1b are compressed into AAC or MP3 format for example. The compressed audio data signal 13 is sent unencrypted from the playback device 21 to an amplifier 24, this transmission also taking place via an Ethernet connection in the “streaming” procedure, i.e. as continuous audio data transmission 14, to the amplifier 24.

The amplifier 24 converts the digital data into an analog audio signal 17 during a digital-analog audio data conversion 15.

Before the analog audio data signal 17 is sent to the loudspeaker 25 to be output, the audio data 1b is delayed within the amplifier. An audio delay 16 function, which is implemented in software for example, delays the signal by a predetermined time period. In this case, the delay 16 is not determined dynamically with respect to the runtime, but rather is fixed on account of the design of the data network components, i.e. it is advantageously already set at the design stage of the data network. Accordingly, the delay 16 is advantageously static and/or temporally uncontrolled or irregular.

Said predetermined time period corresponds to the difference between the runtimes of the audio and video data 1a, 1b for a system not having a delay function of this kind. Generally, the runtime of the video data 1a is longer than the runtime of the audio data 1b, since the video data 1a have to be encrypted and decrypted. The time period is therefore dimensioned such that the audio and video data 1a, 1b are simultaneously played back, although the audio data 1b could actually be played back more quickly.

Following the above, the audio and video data are advantageously already divided into separate data streams in the playback device 21. The separated audio and video data are advantageously compressed separately from one another (operations 2 and 12). The encoded audio and video data are in particular transmitted or streamed from the playback device 21 to the video decoder 22 or the amplifier 24 separately from one another.

A data network according to the invention makes it possible to connect a plurality of playback devices, such as additional screens 23 and additional loudspeakers 25, and for said devices to also be able to receive the continuous audio and video data stream.

If structurally identical decoders 22 and amplifiers 24 are provided before the playback devices, the playback is synchronous not only at matching end devices (such as the screen 23 and loudspeaker 25), but at all playback devices connected in the network. This synchronous playback on all end devices is advantageous in an airplane, in particular, since different end devices can be perceived at the same time, and so synchronization differences appear particularly disturbing.

### LIST OF REFERENCE NUMERALS

1 Data carrier

1a Video data

1b Audio data

2 Video data compression

3 Compressed video data signal

4 Video data encryption

5 Continuous video data transmission (streaming)

6 Encrypted video data signal

7 Video data decryption

8 Video data decompression

9 HDMI video data transmission

10 Digital-analog video data conversion

11 Video output

12 Audio data compression

13 Compressed audio data signal

14 Continuous audio data transmission (streaming)

15 Digital-analog audio data conversion

16 Audio data delay

17 Analog audio data signal

18 Audio output

21 Playback device

22 Decoder

23 Screen

24 Amplifier

25 Loudspeaker

31 Operation

32 Component

33 Data

1-15. (canceled)

16. A data network in an in-flight entertainment system for playing back video data and audio data, comprising:
a playback device, wherein the playback device is configured to read out video data and audio data from a data carrier;
a decoder, wherein the video data read out by the playback device is transmitted to the decoder in an encrypted manner, wherein the decoder outputs an output video data signal; and
an amplifier, wherein the audio data read out by the playback device is transmitted to the amplifier, wherein the amplifier outputs an output audio data signal;
wherein the video data read out by the playback device is transmitted to the decoder separately from the audio data read out from the playback device transmitted to the amplifier,
wherein the data network is configured such that when a video output device receives the output video data signal and an audio output device receives the output audio data signal, the video output device plays back the video data read out by the playback device and the audio output device plays back the audio data read out by the playback device,
wherein playback of the video data by the video output device or playback of the audio data by the audio output device is delayed by a predetermined time period such that a latency between the playback of the video data by the video output device and the playback of the audio data by the audio output device is less than 0.5 seconds.

17. The data network according to claim 16,
wherein the playback device applies video data compression to the video data read out by the playback device to produce a compressed video data signal,
wherein the playback device applies video data encryption to the compressed video data signal to produce an encrypted compressed video data signal,
wherein the encrypted compressed video data signal is transmitted to the decoder in a continuous video data transmission such that the decoder receives a received encrypted compressed video data signal,
wherein the decoder applies video data decryption to the received encrypted compressed video data signal to produce a received compressed video data signal,
wherein the decoder applies video data decompression to the received compressed video data signal to produce the output video data signal,
wherein the playback device applies audio data compression to the audio data read out by the playback device to produce a compressed audio data signal,
wherein the compressed audio data signal is transmitted to the amplifier in a continuous audio data transmission such that the amplifier receives a received compressed audio data signal,
wherein the amplifier converts the received compressed audio data signal to an analog audio data signal and outputs the analog audio data signal as the output audio signal.

18. The data network according to claim 17, further comprising:
the video output device, wherein the video output device is a screen; and
the audio output device, wherein the audio output device is a loudspeaker.

19. The data network according to claim 16, wherein the video data has a resolution of at least 720p.

20. The data network according claim 16, wherein the data network comprises a digital rights management system (DRM system).

21. The data network according to claim 16, wherein the data network comprises:
video data processing components, wherein the video data processing components process the video data read out by the video output device, wherein durations of operations of the video data processing components are deterministic; and
audio data processing components, wherein the audio data processing components process the audio data read out by the audio output device, wherein durations of operations of the audio data processing components are deterministic.

22. The data network according to claim 16,
wherein a video data runtime is a total of the durations of the operations of the video data processing components,
wherein an audio data runtime is a total of the durations of the audio data processing components,
wherein the predetermined time period is within 0.5 seconds of a difference between the video runtime and the audio runtime.

23. A method for playing back video data and audio data in an in-flight entertainment system via a data network, comprising:
providing a data network;
providing video data and audio data;
passing the video data through the following:
a) data compression;
b) data encryption;
c) continuous data transmission;
d) data decryption;
e) data decompression;
f) digital-analogue data conversion; and
g) data playback;
passing the audio data through at least (a), (c), (e), (f), and (g),
wherein, at least in (c) the video data and audio data are transmitted separately via the data network,
wherein during (e) or (f), the audio data is delayed by a predetermined time period such that the video data and audio data are played back with a latency between playback of the video data and playback of the audio data of less than 0.5 seconds.

24. The method according to claim 23, wherein the video data and the audio data pass through (a), (c), (e), and (f) separately.

25. The method according to claim 23, wherein the data network comprises:
a playback device, wherein the playback device is configured to read out video data and audio data from a data carrier;
a decoder, wherein the video data read out by the playback device is transmitted to the decoder in an encrypted manner, wherein the decoder outputs an output video data signal; and
an amplifier, wherein the audio data read out by the playback device is transmitted to the amplifier, wherein the amplifier outputs an output audio data signal;
wherein the video data read out by the playback device is transmitted to the decoder separately from the audio data read out from the playback device transmitted to the amplifier,
wherein the data network is configured such that when a video output device receives the output video data signal and an audio output device receives the output audio data signal, the video output device plays back the video data read out by the playback device and the audio output device plays back the audio data read out by the playback device.

26. The method according to claim 25,
wherein the playback device applies video data compression to the video data read out by the playback device to produce a compressed video data signal,
wherein the playback device applies video data encryption to the compressed video data signal to produce an encrypted compressed video data signal,
wherein the encrypted compressed video data signal is transmitted to the decoder in a continuous video data transmission such that the decoder receives a received encrypted compressed video data signal,
wherein the decoder applies video data decryption to the received encrypted compressed video data signal to produce a received compressed video data signal,
wherein the decoder applies video data decompression to the received compressed video data signal to produce the output video data signal,
wherein the playback device applies audio data compression to the audio data read out by the playback device to produce a compressed audio data signal,
wherein the compressed audio data signal is transmitted to the amplifier in a continuous audio data transmission such that the amplifier receives a received compressed audio data signal,
wherein the amplifier converts the received compressed audio data signal to an analog audio data signal and outputs the analog audio data signal as the output audio signal.

27. The method according to claim 26, wherein the data network further comprises:
the video output device, wherein the video output device is a screen; and
the audio output device, wherein the audio output device is a loudspeaker.

28. The method according to claim 23, wherein the data network comprises:
video data processing components, wherein the video data processing components process the video data read out by the video output device, wherein durations of operations of the video data processing components are deterministic; and
audio data processing components, wherein the audio data processing components process the audio data read out by the audio output device, wherein durations of operations of the audio data processing components are deterministic,
wherein a video data runtime is a total of the durations of the operations of the video data processing components,
wherein an audio data runtime is a total of the durations of the audio data processing components,
wherein a video data runtime is a total of the durations of the operations of the video data processing components,
wherein an audio data runtime is a total of the durations of the audio data processing components,
wherein the video data runtime is predetermined,
wherein the audio data runtime is predetermined.

29. The method according to claim 23,
wherein in (a), audio data of at most 48 kHz and 16 bits is generated.

30. The method according to claim 23,
wherein in (a), video data is generated via intra-frame and inter-frame coding.

31. The method according to claim 23,
wherein the data network comprises a playback device, wherein the video data and the audio data are transmitted separately in the playback device and, subsequently, the video data is transmitted separately from the audio data to a decoder and the audio data is transmitted separately from the video data to an amplifier.

32. A playback device for reading out video data and audio data from a data carrier for an in-flight entertainment system,
wherein the playback device is configured to read out video data and audio data from a data center, wherein the playback device is configured to transmit the video data read out by the playback device in an encrypted manner, separately from the audio data read out by the playback device, to a decoder, wherein the playback device is configured to transmit the audio data read out by the playback device, separately to an amplifier.

33. The playback device according to claim 32,
wherein the playback device applies video data compression to the video data read out by the playback device to produce a compressed video data signal,
wherein the playback device applies video data encryption to the compressed video data signal to produce an encrypted compressed video data signal,
wherein the playback device outputs the encrypted compressed video data signal in a continuous video data transmission,
wherein the playback device applies audio data compression to the audio data read out by the playback device to produce a compressed audio data signal,
wherein the playback device outputs the compressed audio data signal in a continuous audio data transmission.

34. The playback device according to claim 32,
wherein the video data has a resolution of at least 720p,
wherein the compressed video data signal is generated via intra-frame and inter-frame coding.

35. The playback device according to claim 33,
wherein the compressed audio data signal is at most 48 kHz and 16 bits.
